(19) United States
(12) Patent Application Publication
(10) Pub. No.: US 2026/0145891 A1
(43) Pub. Date: May 28, 2026

(54) DRIVERLESS TRANSPORT SYSTEM INCLUDING A PASSIVE TRANSFER STATION FOR EXCHANGE AND STATIC PROVISION OF TRANSPORT ITEMS

(71) Applicant: SSI Schäfer Automation GmbH (DE), Giebelstadt (DE)

(72) Inventors: Ralf KLEEDÖRFER, Marktheidenfeld (DE); Vitali HUCK, Bremerhaven (DE)

(21) Appl. No.: 19/484,489

(22) PCT Filed: May 7, 2024
(86) PCT No.: PCT/EP2024/062618

§ 371 Date: Nov. 14, 2025

(30) Foreign Application Priority Data
May 17, 2023 (DE) 10 2023 113 092.7

(51) Int. Cl. B65G 67/02

(52) U.S. Cl. CPC B65G 67/02; B65G 2814/0301

(57) ABSTRACT

There are disclosed an intralogistics system (10) and a method for static provision of transport items (12) comprising: a driverless transport vehicle, DTV, (20); a transfer station (24) for static provision of at least one of the transport items (12) on a deposition surface (28) of the transfer station (24); and a control (48); wherein the DTV (20) comprises a load-handling device, LHD, (34) defining a transport surface (38), on which the at least one of the transport items (12) rests during a transport travel, on an upper side of the DTV (20), wherein the LHD (34) comprises, along a travelling direction (31) of the DTV (20), a first finger member (42) and a second finger member (44), each of which is switchable between a raised position and a lower position; wherein the transfer station (24) is configured to buffer, one behind another one, at least two of the transport items (12) on a corresponding plurality of deposition locations (30) on the deposition surface (28); wherein the transfer station (24) comprises a non-driven multi-track transfer conveyor (26) which defines the deposition surface (28); wherein the transfer conveyor (26) and the LHD (34) are configured to exchange with each other each of the to-be-provided transport items (12) meshingly by the DTV (20) travelling through the transfer station (24); and wherein the control (48) is configured to switch, during passage of the DTV (20) through the transfer station (24), each of the finger members (42, 44) dependent on a travelling depth (DT) between the positions.

### CROSS-REFERENCE TO RELATED APPLICATIONS

This application is a national stage application under 35 U.S.C. 371 of PCT Application No. PCT/EP 2024/062618, having an international filing date of 7 May 2024, which designated the United States, which PCT application claimed the benefit of German Application No. 10 2023 113 092.7, filed 17 May 2023, each of which are incorporated herein by reference in their entirety.

### BACKGROUND

The present disclosure relates generally to an intralogistics system for handling transport items, and in particular for the static provision of at least one of the transport items, such as (standardized) storage containers, comprising: a driverless transport vehicle (DTV); a (passively operated) transfer station for the static provision of at least one of the transport items on a (planar) deposition surface of the transfer station (in production logistics); and a control.

DE 20 2018 101 313 U1 (SSI Schäfer) shows different loading and unloading stations operated by DTVs, which respectively comprise on their upper side a load-handling device formed of elongated webs or (supporting) slats, which are arranged parallel to the travelling direction and spaced to one another horizontally perpendicular to the travelling direction and which define together, on their upper sides, a planar (i.e., flat, even, straight, and non-curved) transport plane, or transport surface, on which the transport items rest or sit during transport. The webs are formed like combs or slats for meshingly receiving and/or delivering the transport items. The receiving and delivering preferably takes place passively, in particular inertia-based, by the DTV travelling, in particular meshingly, through rigidly arranged receiving and delivering members of a loading station (receiving) or of an unloading station (delivery), wherein the members of the stations are correspondingly arranged meshingly so that the members and the webs do not collide with each other during passage. The webs comprise, for the purpose of receiving and delivering, at their, in the travelling direction, upstream or downstream ends fingers which serve as drivers (cf. FIGS. 5 and 6 thereof), pushers (cf. FIG. 14 thereof), or stops (cf. FIG. 10 thereof). The fingers vertically project perpendicular from the transport plane and are immovably fixed to the corresponding ends of the webs.

DE 10 2014 111 396 A1 (SSI Schäfer) shows DTV types of different heights, the slat-like or comb-like webs of which forming the load-handling device comprise at their downstream and/or upstream ends rigid fingers projecting vertically from the transport surface. The fingers can also be formed movably by being extendible and retractable in a height direction. Further, an unloading station and a loading station (cf. FIG. 9 there) including so-called “spaghetti conveyors” (cf. FIG. 8A there) are used. The spaghetti conveyors comprise driven single conveyors, which are spaced perpendicularly to the travelling direction and which are oriented in parallel to the travelling direction in order to mesh with the webs of the DTVs during passage of the DTVs. Alternatively, the webs, or slats, may also be formed in a brush-like manner by bristles (cf. FIG. 8B there), which are elastically deformable so that they are pressed down by the spaghetti conveyor during the passage of the DTV, and which are sufficiently stiff to keep the items, during the transport, at a minimum distance from the upper side of the vehicle.

Since the spaghetti conveyor is driven actively, it is difficult to construct the single conveyors to be narrow. The drive requires space. The cantilevered suspension is complicated because the drive is present. The spaghetti conveyor needs to be monitored by external sensors for synchronizing delivery and receipt of transport items with the DTVs. The control effort during exchange of transport items is significant if the spaghetti conveyor is not operated continuously, which would be energetically disadvantageous.

In general, the DTVs travel through the transfer conveyor (passage) during a meshing exchange of the transport items between the DTVs and a transfer conveyor, and thus underneath a main conveyor system arranged longitudinally adjacent. These DTVs must also emerge again from beneath the main conveyor system. For this purpose, space is required during the planning of the travel paths of the DTVs, which cannot be used otherwise. This restricts the layout designer's planning freedom, which is undesirable. Additionally, the main conveyor system must be positioned higher than usual, which can complicate retrofitting of existing installations. The DTVs could also be configured lower. However, in this case a more complex supporting structure would be required for the passing below the main conveyor system.

U.S. Pat. No. 4,508,484 B (Inventio AG) shows a loading and unloading station through which a DTV meshingly travels (cf. FIGS. 1-4 there). The station comprises a frame (not depicted) with an integrated chain conveyor, the conveyor chains of which are arranged laterally with respect to the passing DTV and are driven by rack bars arranged on an upper side of a housing of the DTV beneath webs. The rack bars engage, during the passage, i.e. during delivery from left to right, a drive pinion of the chain conveyor, which is couplable, via a clutch (not depicted) and an overdrive (not depicted), to the two lateral conveyor chains K. The chain conveyor comprises, on its entry side, an ascending (ramp) portion which transitions into a (horizontal) portion where the transport item is separated from the DTV. Thereafter, the transport item can be transferred from the chain conveyor to a driven continuous conveyor arranged downstream by driving the chain conveyor via a motor (not depicted).

Although this solution eliminates external sensors that synchronize the movements of the DTV and the transfer conveyor during the exchange of transport items, the transmitting drive is disadvantageous. The DTVs and the transfer conveyor come into mechanical contact for the overdrive, which requires accurate alignment and results in an increased wear. Minor height differences between the rack bars on the DTVs and the drive pinions of the transfer conveyor may result in a mechanical blockage if the rack bars are positioned too high, or in a failure of the drive of the transfer conveyor if the rack bars are positioned too low. The rack bars arranged on the left and right sides of the DTV must be positioned accurately with respect to one another in the longitudinal direction of the DTV in order to operate the left and right conveyor chains of the transfer conveyor synchronously. The mechanical overdrive therefore places high demands on the positioning accuracy, which are difficult to meet in practical operation.

JP 1986 050 853 B2 (SHINKO ELECTRIC CO LTD) discloses in its FIGS. 1-4 a transfer station coupled on one side to a DTS and on the other side to a driven roller conveyor. A transport platform (load-handling device) provided on the upper side of the DTV is provided with two vertically lowerable push plates that can be activated individually. The transport platform interacts meshingly with the transfer station, which has a ramp-shaped input/output portion and a horizontal buffer portion and which is formed of two tracks of freely rotating rollers. The horizontal portion is coupled to the driven roller conveyor. During delivery of the transport item to the roller conveyor, the rear push plate first pushes the transport item resting on the platform onto the ascending portion and then onto the horizontal portion while the DTV travels into the transfer station, thereby separating the transport item from the platform. Subsequently, the DTV (with raised or lowered) push plate travels backward again from the transfer station so that the delivery is completed (cf. FIG. 4 there). During receipt, the transport item is conveyed by the roller conveyor onto the non-driven horizontal portion of the transfer station so that the DTV can travel underneath the transport item, which is already provided there, (with lowered push plates) by the DTV travelling into the station with lowered plates. Then, the front push plate is extended (during the entry) in order to pull the transport item from the horizontal portion while the DTV travels backward out of the transfer station. During this process, the transport item is drawn from the horizontal portion into the inclined portion, and from there onto the DTV platform (cf. FIG. 3 thereof). In this solution, the transfer station consisting of two portions is very long so that a lot of space is lost. During transfer of a transport item (delivery or receipt) the DTV must travel forward and backward and can perform either delivery or receipt at a time. The DTV cannot perform delivery and receipt during the same travel cycle. This reduces the throughput (number of transfers per unit of time).

U.S. Pat. No. 11,148,890 B2, in accordance with its title, relates to mobile carriers for use in systems as well as to a method for processing objects including mobile matrix carrier systems.

10 2015 114 370 A1, in accordance with its title, relates to a driverless transport system in storage and order-picking facility.

In general, there is a need in intralogistics, and in particular in production logistics, to provide and retrieve transport items at a high throughput. For example, machines that automatically process and/or produce semi-finished goods (raw materials, preprocessed materials, semi-finished workpieces, blanks, intermediate products, etc.) or finished products must be continuously supplied with empty transport containers or cartons (standardized in dimensions), into which the products are placed and which are transported to other logistics points (next processing station, warehouse, shipping, goods issue, etc.). Also, such machines must be supplied with material that is likewise provided in transport containers or cartons. The transport containers remain for a certain period of time (at accurately predefined locations) at the machines, i.e. they are provided statically. The transport itself is preferably carried out using a driverless transport system (DTS) including one or more driverless transport vehicles (DTVs). The exchange time of transport containers should be as short as possible. During this exchange time the machine either is not supplied with material or cannot output or discharge products.

Therefore, it is an object of the present disclosure to provide an intralogistics system and a method for static provision of at least one transport item, which are overcoming the above-mentioned disadvantages at least partially.

This object is solved by an intralogistics system for handling (provision and/or transport) of (standardized, in particular with regard to a minimum width and a minimum length) transport items, and in particular for static provision, of at least one of the transport items, comprising: a driverless transport vehicle, DTV; a (passively operated) transfer station for static provision of at least one of the transport items on a (planar) deposition surface of the transfer station (preferably in production logistics); and a control; wherein the DTV comprises a load-handling device, LHD, defining a (planar) transport surface on an upper side of the DTV, on which the at least one of the transport items rests during a transport travel, wherein the load-handling device comprises, along a travelling direction of the DTV, a first finger member and a second finger member, each of which is switchable between a raised position and a lowered position; wherein the transfer station is configured to buffer, one behind the other, (spaced apart) at least two of the transport items on a corresponding plurality of deposition locations on the deposition surface; wherein the transfer station comprises a non-driven multi-track transfer conveyor defining the deposition surface; wherein the transfer conveyor and the load-handling device are configured (and arranged) to exchange each of the to-be-provided transport items meshingly with each other (in particular to deliver and to receive the same) by the DTV travelling through the (entire) transfer station (without change of travelling direction); and wherein the control is configured to switch each of the finger members, depending on a travelling depth (alternatingly), between the positions (back and forth) while the DTV travels through the transfer station.

In the travelling direction of the DTV the transfer station is short. A ramp-shaped input portion is not required. The DTV can travel completely through the transfer station even if the finger members are in their raised positions, which enables both the delivery and receipt of respectively one transport item during one and the same passage of the DTV.

The DTV does not need to travel forward and backward in order to deliver or receive a transport item. Thereby, the (travel) control is simplified.

The throughput is increased because less time is required for an exchange.

The intralogistics system is particularly suitable for use in production logistics where the transport items are to be provided statically.

Preferably, each of the finger member projects in the respective raised position (vertically) beyond the deposition surface and the transport surface, and is positioned in the respectively lowered position below the deposition surface.

This allows the finger members to push transport items located on the DTV onto the transfer station, and to pull transport items located on the transfer station. In addition, transport items on the transfer station can also be passed underneath without pushing or pulling them.

Preferably, the deposition locations are spaced apart from one another in the travelling di-rection of the DTV.

This measure allows the finger members to be movable in-between the transport items located on the transfer station without undesirably repositioning these transport items. Transport items to be received can be selected in this way.

In particular, the DTV travels through the entire transfer station without a change of travelling direction.

In this manner, first one of the transport items can be delivered to the transfer station and during the same passage second one of the transport items can be received from the transfer station. The throughput is increased while the control of vehicle remains simple.

Preferably, each of the transport items is standardized with respect to its width, and in particular also with respect to its length.

This measure enables the meshing exchange between the DTV and the transfer station.

Preferably, at least the first finger member is in the raised position upon entry into the transfer station, is switched into the lowered position during the passage depending on a first travelling depth, and is then switched back into the raised position depending on a second travelling depth, wherein the first travelling depth is smaller than the second travelling depth.

This measure allows the delivery of a first transport item and the receipt of an additional transport item during the same passage by one single DTV only, which increases the throughput. The time in which the first deposition location is unoccupied, i.e. in which no transport item is provided there, is zero in practice, which cannot be achieved by two separate DTVs for the delivery and receipt.

In particular, the deposition surface is defined by uppermost points of the multi-track transfer conveyor. The deposition surface is arranged higher than the transport surface.

These measures also assist the meshing exchange between the LHD and the transfer station.

Preferably, the system comprises a sensor for determining a current position of the DTV, in particular while the DTV travels through the transfer station, wherein: the control is electronic; the control communicates with the sensor; the control is configured to determine a travelling depth of the DTV; and the control is configured to generate signals based on the travelling depth, which cause the finger members to be moved into their raised position and into their lowered position.

The object is further solved by a method for static provision of transport items in an intralogistics system which comprises: a driverless transport vehicle, DTV, including a load-handling device, LHD, which comprises first and second finger members switchable respectively between a raised position and a lowered position; a transfer station including a transfer conveyor for static provision of at least one of the transport items on a deposition surface of the transfer station, which includes first and second deposition locations, wherein the transfer conveyor and the LHD are configured to meshingly exchange with each other each of the to-be-provided transport items other by the DTV travelling through the transfer station; and a control; wherein the method comprises the steps of: the DTV travelling into the transfer station, the DTV being loaded with a first one of the transport items, wherein the first and second finger members are in their raised positions; while the DTV travels in, pushing the first transport item with the first finger member onto the transfer conveyor and pulling a second one of the transport items located on the first deposition location, which is defined by the transfer conveyor, with the second finger member onto the second deposition location; once the first transport item has been pushed on the first deposition location, moving the first and second finger members into their lowered positions; the DTV continuing to travel with lowered first and second finger members until the first finger member is movable into its raised position without repositioning the first transport item on the first deposition location, and then moving the first finger member into its raised position; and pulling the second transport item from the second deposition location with the first finger member while the DTV, the first finger member of which is again in the raised position, travels out of the transfer station.

This method enables the advantages already described above.

It is understood that the above-mentioned and hereinafter still to be explained features of the present disclosure cannot be used in the respectively given combination only but also in other combinations or alone without departing from the scope of the claimed invention.

### BRIEF DESCRIPTION OF THE DRAWINGS

Additional features and advantages of the invention result from the description of preferred embodiments below with reference to the drawings.

FIG. 1 shows a block diagram of an intralogistics system;

FIG. 2 shows a block diagram of a DTV;

FIGS. 3A-3E show a sequence of an exchange of transport items between a DTV and a transfer station;

FIG. 4 shows a side view of a transfer station;

FIG. 5 shows a rear view of the transfer station of FIG. 5;

FIG. 6 shows a detailed view of FIG. 4;

FIG. 7 shows a flow chart of a method for static provision of at least one transport item;

FIG. 8 shows a side view of a further transfer station for providing multiple transport items;

FIGS. 9A-9C show a sequence of an exchange of several separated transport items between a DTV and a transfer station;

FIGS. 10A-10H show a sequence of an exchange of respectively one transport item on two transfer stations with two transport items being conveyed separately on a DTV; and

FIGS. 11A-11F show a sequence of an exchange of space-apart transport items on a transfer station with a DTV conveying multiple separated transport items.

### DETAILED DESCRIPTION

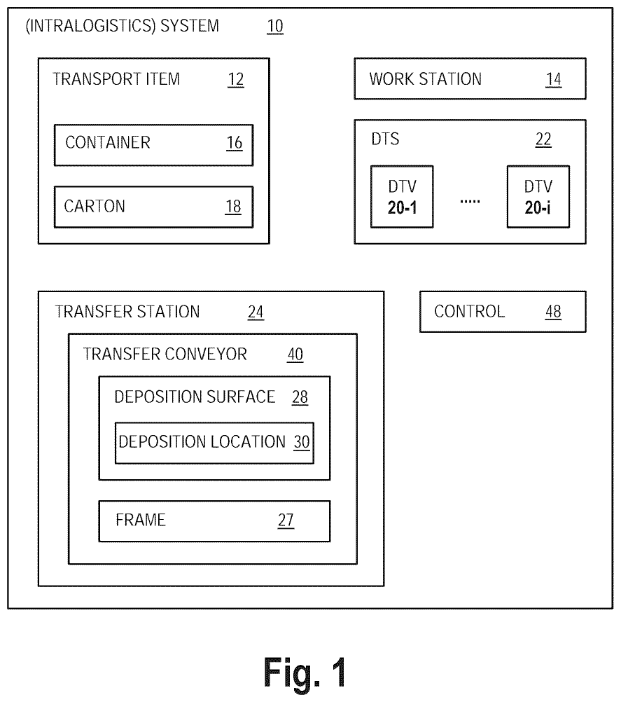

The invention is used, for example, in an intralogistics system 10 of FIG. 1. The system 10 can be a storage and order-picking system (not depicted, such as a distribution facility), a production system, or the like, where transport items 12 are transported between a warehouse (not depicted) and a workstation 14 (not depicted, such as an order-picking station, machine workstation, packing station, etc.) or between the workstation 14 and the warehouse or shipping (material flow). The system 10 may also be used in production, where one or more workstations 14 are to be supplied with material and where empty transport containers 16, waste, and/or finished (intermediate) products are to be retrieved and, if necessary, stored again afterwards. As is customary in (intra)logistics, a longitudinal direction is designated “X”, a transverse direction “Z”, and a height direction “Y” in the following. Preferably, the directions X, Y, and Z define a Cartesian coordinate system.

Hereinafter, a (transport) “item” is to be understood as, for example, a transport unit which is to be transported within the intralogistics system 10 from a starting point (source) to a destination point (sink). The item, also referred to as a transport item 12, may include a (storage) load carrier such as a transport container 16 and, where applicable, products stored therein (not depicted). The item 12 can also be a carton 18 (with or without products contained therein).

For example, pallets, mesh boxes, containers, bins, cartons, trays, (overhead conveyor) pouches, and the like may be used as (storage) load carriers. A “product” may be an individual piece good, or a cohesive group of preassembled (possibly different) piece goods, which is then also referred to as a packaging unit (PU) or case. Products are distinguishable (smallest) units of a product assortment. Piece goods are individualized distinguishable products that can be handled individually.

The transport items 12 may be standardized or unified, in terms of their dimensions, in particular with respect to their base area. The containers 16 may, for example, be Euro-standard containers whose dimensions are standardized according to EN specifications (e.g., VDA standard 4500), which define how such containers must be designed to be suitable for specific functions (e.g., stacking, nesting, etc.). Dimensions (for example, base areas of: 300×200 mm, 400×300 mm, 600×400 mm, 800×600 mm, etc., and heights of: 70, 120, 170, 180, 220, 270, 320, 420 mm, and so on) and construction of the containers 16 may be clearly (and uniformly) specified. In particular, the dimensions of the base area are aligned with the base area of a Euro pallet (1200×800 mm) such that several transport items form one layer of the Euro pallet. However, the containers 16 may be made of different materials. In particular, plastic containers are used that are suitable for storage in automated warehouses (e.g., in AS/RS systems).

One or more driverless transport vehicles (DTVs) 20 are part of a driverless transport system (DTS) 22. The following explanations apply to each of the DTVs 20 used in the DTS 22.

The DTV 20 is an automated, preferably guided, vehicle that performs transport tasks within the system 10 quickly, cost-efficiently, and in a scalable manner. Also, the DTV 20 can be operated completely autonomous by determining its way through the system 10 independently and without mechanical guidance (and fleet control). In particular, the DTV 20 may be a “WEASEL” (registered trademark of SSI Schäfer). The DTV 20 comprises a meshing load-handling device, LHD, which will be explained in more detail below.

The DTV 20 is a discontinuous conveyor and preferably moves along a predefined transport network (not depicted) which may be formed, for example, by lines applied to or painted on the floor of a building and connecting the way points of the network to one another. Alternatively, discrete (grid) points may be used as way points for navigation, which can be connected to each other by virtual lines. Along this transport network, for example, RFID markers may be provided as an implementation of way points. A line between two adjacent way points is referred to as a (conveying or transport) path hereinafter. It is understood that the paths may be implemented in terms of virtual connection lines, for example, when an internal GPS or laser navigation system is used. The same applies analogously to the way points.

The system 10 comprises, in addition to the at least one DTV 20, one or more transfer stations 24.

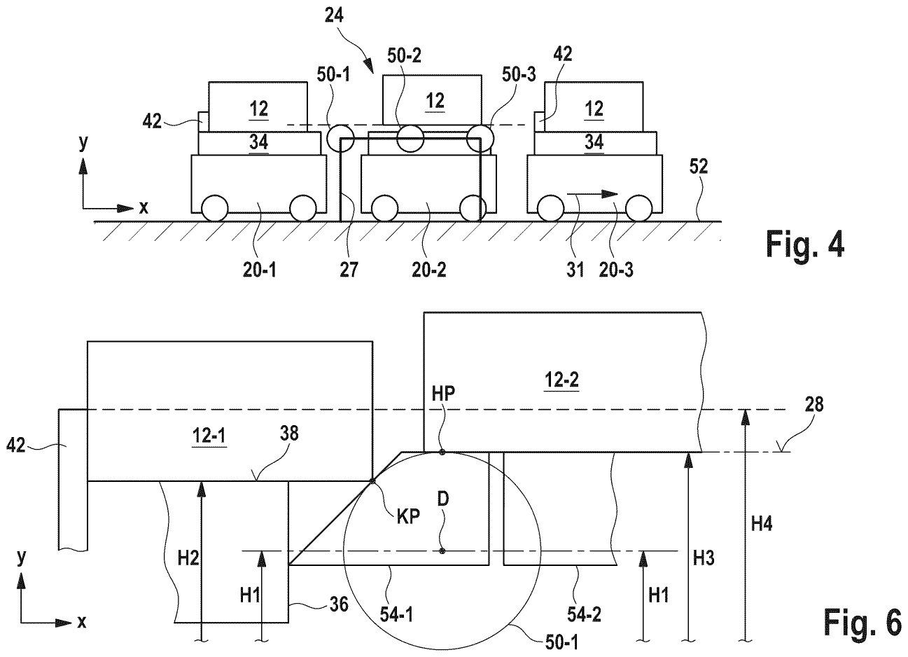

Each of the transfer stations 24 comprises, preferably exclusively, one (single) multi-track transfer conveyor 26 defining a deposition surface 28. Each of the transfer stations 24 comprises a frame 27, which may also form part of the transfer conveyor 26. The transfer conveyor 26 comprises at least two (outer) tracks. Preferably, the transfer conveyor 26 is non-driven. The transfer conveyor 26 may be aligned parallel to a floor 52 (cf. FIG. 4) on which the system 10 is installed, wherein the transfer conveyor 26 is preferably oriented horizontally.

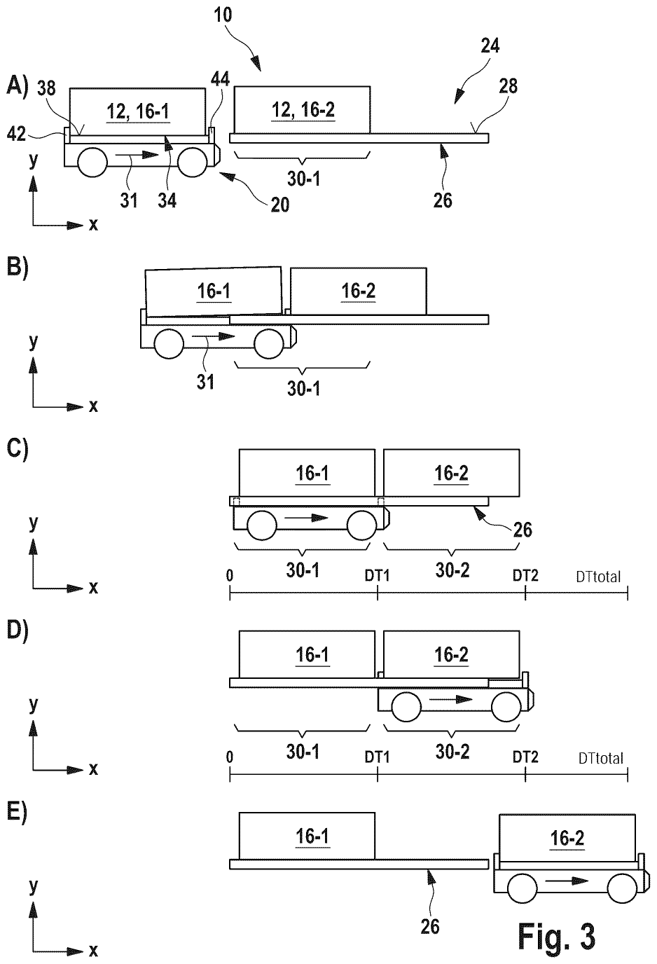

Preferably, each of the transfer stations 24 is operated passively, i.e. the stations have no dedicated drive for moving the transport items 12, and is configured for the static provision of at least one of the transport items 16 on the (in particular planar) deposition surface 26. This means in particular that several of the transport items 12 can be provided statically, one behind the other, on a corresponding number of deposition locations 30 along a travelling direction 31 (cf. FIG. 3) while the DTV 20 passes through the transfer station 24. The term “statically provided” means that the transport items 12 remain stationary for a certain period of time at a predefined location without being moved.

Each of the transfer stations 24 is configured to buffer, one behind the other, at least two of the transport items 12 on a corresponding plurality of deposition locations 30 which form part of the deposition surface 28. The transport items 12 can be buffered at a distance from one another in the travelling direction 32 in order to allow engagement of finger members of the DTV-LHD, as will be explained in more detail below.

It is understood that the system 10 may include additional non-depicted components that will be explained in more detail below.

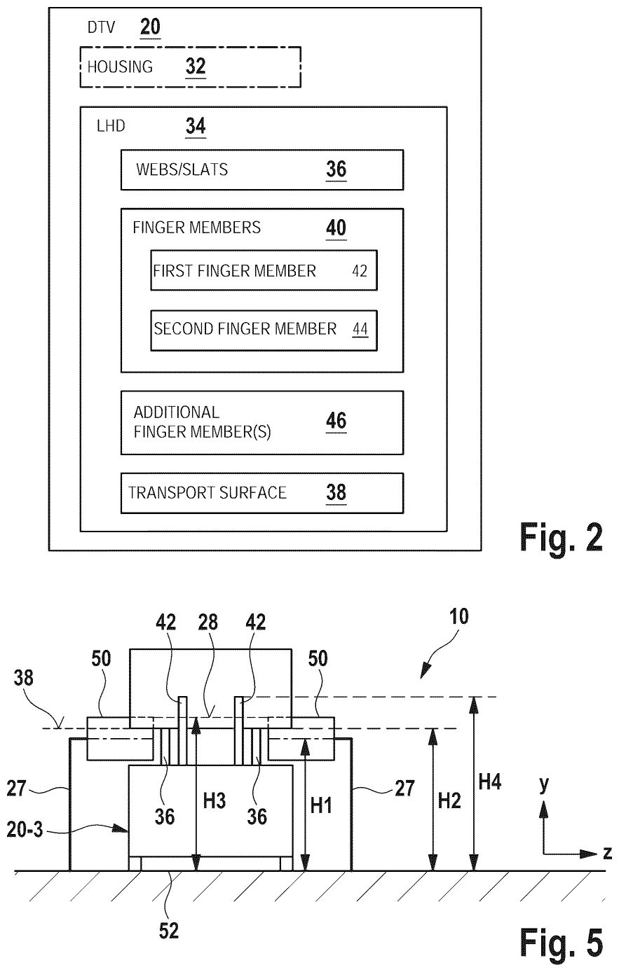

FIG. 2 is a block diagram of the DTV 20. The following explanations apply to each of the DTVs 20 in the system 10 of FIG. 1.

The DTV 20 can comprise a housing 32. The DTV 20 comprises a load-handling device, LHD, 34. The LHD 34 is provided on an upper side of the DTV 20 for carrying and transporting the transport items 12 resting or sitting thereon.

For example, the LHD 34 can be formed of several webs or slats 36, as described above. The webs 36 are oriented parallel to the longitudinal direction of the DTV 16, and thus parallel to the travelling direction of the DTV 20, and are spaced apart from one another in the transverse direction Z. The webs 36 extend upward along the direction Y, and define free spaces between them, into which the transfer conveyor 26 (not depicted) of the transfer stations 24 can immerse meshingly, while the DTV 20 enters or exits, parallel to the direction X, the transfer station 24, or travels through the (entire) transfer station 24. The upper sides of the webs 36 jointly define a planar transport surface 38 on which the one or more transport items 12 rest during travel with the DTV 20.

The LHD 34 further comprises (switchable) finger members 40, each of which is switchable between a raised position and a lowered position. Two of the finger members 40 are preferably provided in end portions (in the longitudinal direction or travelling direction 31 of the DTV 20) of the webs 32. In FIG. 2, for example, a first (rear, upstream in the travelling direction of the DTV 20) finger member 42 and a second (front, downstream in the travelling direction of the DTV 20) finger member 44 are shown. Additional finger members 46 may be provided at predetermined intervals between the (longitudinal outer) first and second finger members 42 and 44. The finger members 40 may be spaced apart from one another in the longitudinal direction of the DTV 20 such that one (or more standardized) transport items 12 can be arranged between them with a clearance. The clearance, i.e. the longitudinal difference between each clear distance of the fingers, which may define a region of transport (length), and the provided transport-item length, can be at least large enough that, taking into account the travel-positioning accuracy of the DTV and the length tolerance of the transport items, the exchange operation described below can be carried out reliably without the finger members 40, which are switched from the lowered to the raised position, unintentionally colliding with the transport items 12.

FIG. 3 schematically illustrates the system 10 of FIG. 1 during an exchange of, for example, one transport item 12 between the DTV 20 and the transfer station 24. For example, the transport item 12 is implemented as a container 16. Other types of transport items 12 may likewise be used. It is understood that more than one container 16 may also be exchanged (simultaneously).

In general, an exchange is to be understood as a delivery of at least one of the transport items 12 by the DTV 20 to the transfer station 24, or as a receipt of at least one of the transport items 12 by the DTV 20 from the transfer station 24. In particular, an exchange includes both the delivery and the receipt—thus, the delivery and the receipt—of at least one transport item 12, in particular during a passage of the DTV 20 through the (entire) transfer station 24.

FIG. 3 shows a chronological sequence of an exchange (delivery and receipt) of, for example, one container 16 between the DTV 20 and the transfer station 24 in terms of five exemplary snapshots (FIGS. 3A-3E). In FIG. 3, the exchange includes the delivery of a first container 16-1 and the receipt of a second container 16-2 while the DTV 20 travels (linearly) in the travelling direction 31 (here parallel to the longitudinal direction X of the system 10) through the entire transfer station 24. It is understood that the container 16 could also be only delivered or only received.

The first container 16-1 can be empty, and the second container 16-2 can be filled when the (stationary) transfer station 24 is positioned in the immediate vicinity of, for example, a (not depicted) production machine dispensing the (produced or processed) products into the statically provided container 16-2. As soon as this container 16-2 is filled with a predetermined number of products, or is full, it must be exchanged as quickly as possible and replaced by the empty container 16-1 in order to avoid standstill of the machine.

Alternatively, the transfer station 24 may be positioned, for example, in the region of an order-picking station (not depicted) where a human or robot, in accordance with picking orders, places predetermined products of a specified type and quantity (from storage containers not illustrated here) into the (order) container 16-2 which is then exchanged for the new (order) container 16-1 once the container 16-2 is full or the order has been processed.

It is understood that even the first container 16-1 could be full and the second container 16-2 could then be empty, wherein the products are removed from the containers 16 at the location of the transfer station 24 rather than being delivered to them, which applies regardless of the specific application (production, order picking, etc.).

In particular, during the exchange the DTV 20 does not travel forward and backward, i.e. into and from the station 24, so that the DTV 20 travels through the station 24 without change of direction.

FIG. 3A shows an initial situation of a (simple) exchange of containers. The first (empty) container 16-1 rests on the LHD 34 of the DTV 20 and is to be delivered to the transfer station 24 by the DTV 20. The second (full) container 16-2 sits on a first deposition location 30-1 where the products are placed into the second container 16-2. The DTV 20 travels in the travelling direction 21 (linearly) along the longitudinal direction X to the transfer station 24, of which only the transfer conveyor 26 is illustrated in FIG. 3. In FIG. 3A the finger members 40, here the first and second finger members 42 and 44, respectively are in their raised position, in which the finger members 40 project (vertically) beyond the transport surface 38 and the deposition surface 28. In the lowered position (not shown in FIG. 3A) the finger members 40 are positioned below the transport surface 38.

It is understood that it may be sufficient if only the rear first finger member 42 were in its raised position in order to prevent the container 16-1 from slipping during the travel.

In addition, it is understood that, in general, multiple first and/or second finger members may be arranged distributed across the width of the LHD 34 in the transverse direction Z, i.e. perpendicular to the drawing plane of FIG. 3. Preferably, the same number of finger members 40 is distributed across the width of the LHD as there are webs 36 provided. However, fewer finger members 40 may also be provided across the widths of the LHD.

It is particularly preferred to provide two finger members 40 in or on the outermost webs 36 of the LHD 34, which can prevent rotation of the transport item 12 during the exchange.

In FIG. 3B the DTV 20 has entered (overlappingly) the transfer station 24. The front second finger member 44 is in its raised position and therefore pushes the second container 16-2 of the first deposition location 30-1. At the same time, the rear first finger member 42 pushes the first container 16-1 onto the first deposition location 30-1. These movements are continued until the first container 16-1 has been completely pushed onto the first deposition location 30-1, as shown in FIG. 3C.

In FIG. 3C the first container 16-1 is positioned on the first deposition location 30-1 and the second container 16-2 is positioned on the second deposition location 30-2. The deposition locations 30-1 and 30-2 are spaced from one another, along the travelling direction 31, by at least a thickness (in the direction X) of the second finger member 44. In FIG. 3C the DTV 20 is located in a position corresponding to a travelling depth DT1. The travelling depth DT1 is defined such that the DTV 20 has entered the transfer station 24 so deep that the first container 16-1 is positioned on the first deposition location 30-1. When the DTV 20 has reached the travelling depth DT1 the DTV 20 preferably stops briefly in order to move the first finger member 42 and the second finger member 44 into their respective lowered positions, as also shown in FIG. 3C.

Subsequently, the DTV 20 continues to travel in the travelling direction 31 with the finger members 42 and 44 lowered until it reaches the travelling depth DT2, as shown in FIG. 3D. The travelling depth DT2 is defined such that the first finger member 42 can be moved into a gap between the containers 16, without repositioning the first container 16-1. This means that the first container 16-1 remains on the first deposition location 30-1 when the first finger member 42 is moved into its raised position again. For this purpose, the DTV 20 may preferably stop briefly. At this time, the first and second finger members 42 and 44 can be moved again into their respective raised position. It is not strictly necessary for the second finger member 44 to also be moved into its raised position.

Then, the DTV 20 continues to travel in the travelling direction 31 through the transfer station 24 until the transfer station 24 has been passed completely. During this process, the first finger member 42 pulls the second container 16-2 from the second deposition location 30-2 onto the (lower positioned) LHD 34. The DTV 20 receives the second container 16-2. This situation is shown in FIG. 3E. The DTV 20 has reached the maximum travelling depth DTₜₒₜₐₗ as soon as the second container 16-2 is fully positioned on the DTV 20. In FIG. 3E the DTV 20 has travelled even slightly beyond the maximum travelling depth DTₜₒₜₐₗ. In this state, the second container 16-2 has been completely received by the DTV 20. This means that the second container 16-2 is positioned exclusively on the DTV 20. In this case, the second deposition location 30-2 is empty, i.e. unoccupied. Thus, the second container 16-2 can be exchanged for the first container 16-1 by the DTV 20 (meshingly) travelling through the entire transfer station 24 (passage) without change of travelling direction, i.e. without moving back and forth.

The travelling depth DT indicates how far the DTV 20 has already travelled through the transfer station 24. The travelling depth DT may, for example, be measured with respect to the location of the foremost (here second) finger member 40. During the passage, the LHD 34 and the transfer conveyor 26 overlap at least partially.

As can be seen from FIG. 3D, the second container 16-2 projects slightly beyond the transfer conveyor 26 when it is located on the second deposition location 30-2. It is understood that the transfer conveyor 26 could also be formed to be longer so that the second container 16-2 is supported, for example, completely from below by the transfer conveyor 26, i.e. over its entire length (in the direction X). This depends, among other things, on the (expected) mass distribution within the second container 16-2.

Although FIG. 3 shows that the second container 16-2 is exchanged for the first container 16-1, it is also possible to either deliver only the first container 16-1 to the (in this case completely empty) transfer station 24 or to receive only the second container 16-2 from the transfer station 24, wherein in this case the DTV 20 enters the transfer station 24 empty.

In principle, it is also possible to exchange multiple containers 16 (simultaneously) during the travel of the DTV 20 through the transfer station 24. For example, in order to exchange two containers 16 at the same time, both the DTV 20 and the transfer station 24 would have to be formed to be correspondingly long (in the direction X). In this case, the DTV 20 would have to be configured to transport at least three containers 16 at the same time, whereas the transfer station 24 would have to be configured to buffer at least four containers 16 at the same time. The LHD 34 of the DTV 20 would have to comprise, in addition to the first and second finger members 42 and 44, at least one additional (central) finger member 46 (cf. FIG. 2). In this specific case, one additional finger member 46 would be sufficient, which is to be arranged between the first finger member 42 and the second finger member 44 so that three containers 16 (spaced apart from one another) can be transported on the LHD 34.

In general, for exchanging N containers 16, the transfer station 24 comprises at least 2N deposition locations 30. In this case, the LHD 34 can be configured to transport at least 2N-1 containers 16 at the same time, wherein also 2N finger members 40 were to be provided in total. These finger members 40, in turn, were to be switched, depending on the travelling depth DT, between their raised and lowered positions (back and forth).

Thus, the switching of the finger members 40 is also performed depending on the travelling depth DT, as explained above. The switching is generally caused by a control 48. The control 48 is a component of the system 10, see FIG. 1. The control 48 may be implemented electronically and/or mechanically.

If the control 48 is implemented mechanically, cam tracks (for example guide rails) may be used which are mounted on the floor 52 and/or on the frame 27 along the transfer station 24 and interact with, for example, cam followers (not depicted) with which the DTV 20 is provided. These cam followers may be coupled to the finger members 40 and may be moved by the cam tracks depending on the travelling depth DT, wherein movement of the cam followers results in a corresponding movement of the finger members 40.

When the control 48 is implemented electronically, the (current) position of the DTV 20 can be detected by a suitable sensor (not illustrated), in particular to determine the travelling depth DT of the DTV 20. Based on the correspondingly determined travelling depth DT, the control 48 can generate signals causing the finger members 40 to be moved into the raised position or into the lowered position. The finger members 40 may be provided with drives (not depicted, such as electric motors) in order to move them back and forth between the positions.

The (electronic) control 48 may be provided (as an independent unit) within the DTV 20. Alternatively or additionally, the (electronic) control 48 may be a component of a higher-level control (e.g., of a material-flow computer) of the system 10, wherein in this case the DTV 20 and the higher-level control communicate with each other (in a wired manner and/or wirelessly).

FIGS. 4 to 6 serve to explain the meshing exchange of transport items 12 between the DTV 20 and the transfer station 24. In particular, the height relationships, which are required for this purpose, are to be illustrated. FIG. 4 shows a schematic side view of a meshing exchange. FIG. 5 shows a schematic rear view. FIG. 6 shows a detailed view of the height relationships.

For simplification of the explanation, FIG. 4a shows, in the side view, a transfer station 24 whose transfer conveyor 26 is formed of, by way of example, three rollers 50-1 to 50-3 that are supported in a freely rotatable manner (i.e. without any drive) in the frame 27 fixed to the floor 52. The, in the travelling direction 31, first roller 50-1 may project beyond the frame 27 in the negative direction X. The, in the travelling direction 31, last roller 50-3 may project beyond the frame 27 in the positive direction X. All three rollers 50 are arranged at a height H relative to the floor 52 such that their highest points HP (cf. FIG. 6) define the planar deposition surface 28 on the transfer station 24.

FIG. 5 shows a rear view of the third DTV 20-3 of FIG. 4 after the DTV 20-3 has received the transport item 12 from the transfer station 24. The upper side of the webs 36 is lower than the highest points HP of the rollers 50. This means that the transport surface 38 is positioned lower than the deposition surface 28. The roller 50 shown in the left in FIG. 5 represents a first track of the transfer conveyor 26. The roller 50 shown on the right in FIG. 5 represents a second track of the transfer conveyor 26. The transfer conveyor 26 of FIG. 5 is also formed by two tracks. These two tracks are located, in the transverse direction Z, outside the (in the direction Z) outermost webs 36 forming the LHD 34.

FIG. 5 also illustrates that the transport items 12 must have a certain width in the direction Z in order to be placed on the tracks of the transfer conveyor 26. The number of transport items 12 to be exchanged simultaneously influences the length of the LHD 34 and of the deposition location(s) 30 in the longitudinal direction X. Thus, it is advisable to use transport items 12 that have certain minimum dimensions with respect to their base area, or bottom surface, which can be ensured, for example, by using standardized containers 16. The height of the transport items 12 is of secondary importance.

FIG. 6 illustrates the height relationships between the webs 36, the transfer conveyor 26, and the finger members 40. The upper side of the webs 36 of the LHD 34 define the transport surface 38. The highest points HP of the (exemplary) rollers 50 define, in the cross sectional view, the deposition surface 28. Height H2 of the undersides of the transport item(s) 12, when transported by the DTV 20, correspond(s) to height H2 of the (planar) transport surface 38.

Rotational axes D of the rollers 50 may be arranged at an (equal) height H1, with H2>H1. This in turn means that a lower front edge of the transport item 12 contacts an upper half of the foremost roller 50-1 during the delivery, which is illustrated by the point of contact (KP) in FIG. 6, while the DTV 20 enters the transfer station 24. The slope (tangent) at the point of contact KP is greater than 0°. The height H2 (und thus the relative height of the webs 36) is furthermore to be selected such that H1<H2<H3 applies. The height H3 corresponds to the height of the deposition surface 28.

The height H4 of the finger members 40 is supposed to project (vertically) beyond the deposition surface 28 so that H4>H3 applies.

It is understood that the transfer conveyor 26 does not have to be formed of rollers 50. Instead of rollers 50 supported in a freely rotatable manner, for example, also sliding-surface elements 54 may be used, which are likewise indicated in FIG. 6. Instead of the first roller 50-1, a first (wedge-shaped) sliding-surface element 54-1 may be used, whose slope can be selected analogously to the roller 50-1. Instead of the further rollers 50-2 to 50-3, one or more additional sliding-surface elements 54-2 (arranged spaced apart to one another) may be used, which may, for example, have a rectangular cross section in the side view of FIG. 6 (and also in a top view, not illustrated) and define together the planar deposition surface 28. The sliding-surface elements 54 may have a surface texture with a suitable coefficient of friction to allow the transport items 12 to slide thereon and also to stop at desired positions (without undesired overrun).

The sliding-surface elements 54 may also be manufactured integrally, preferably from sheet metal, wherein the wedge-shaped sliding-surface element 54-1 may be manufactured by sheet-metal bending. Furthermore, the one or more sliding-surface elements 54-2 preferably may be formed as an L-profile in the direction x. One leg may be oriented horizontally (in the plane XZ) as a sliding surface for the transport items 12, and a second leg may be oriented vertically (in the plane XY) to mount the sliding-surface element 54 to the frame 27. The second leg may also provide horizontal guidance of the transport items 12 along the transfer station 24.

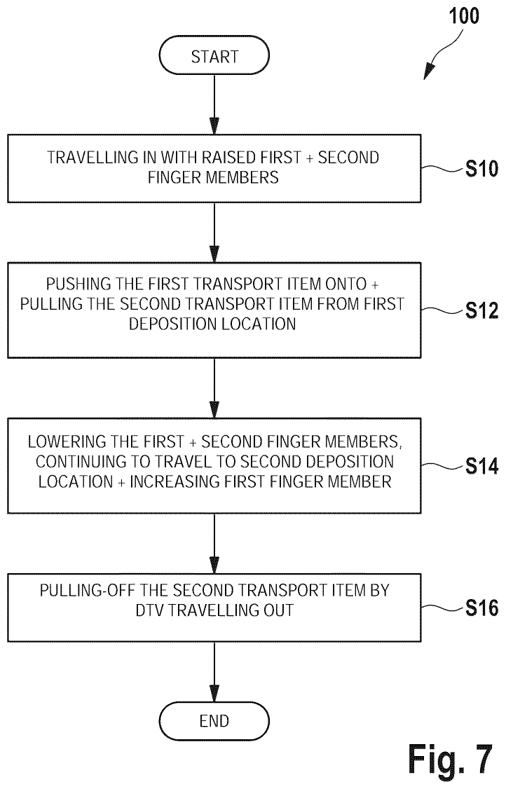

FIG. 7 shows a flow chart of a method 100 for static provision of at least one of the transport items 12. The flow chart of FIG. 7 describes the exchange of one of the transport items 12 shown in FIG. 3 during one single passage of the DTV 20 through the transfer station 24.

The DTV 20 and the transfer station 24 are formed in accordance with FIGS. 1 and 2.

In step S10, the DTV 20, which is loaded with the first one of the transport items 12-1, travels into the transfer station 24, wherein the first and second finger members 42 and 44 are in their respective raised positions.

In the next step S12, the first transport item 12-1 is pushed by the (raised) first finger member 42 onto the first deposition location 30-1 where the second transport item 12-2 is positioned. The second transport item 12-2 is thereby pushed off, while the DTV completely travels in and the first transport item 12-1 has reached the first deposition location 30-1.

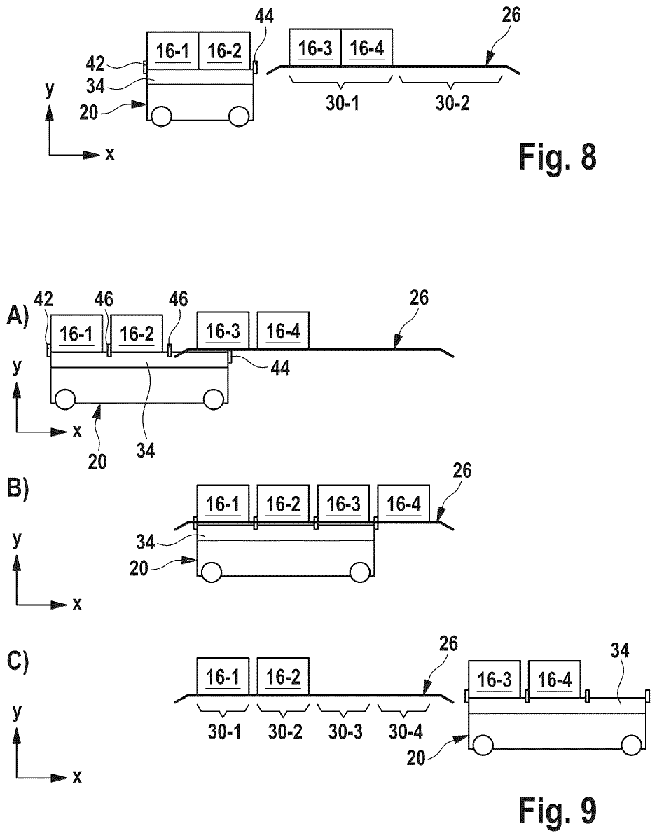

With reference to the FIGS. 8-11, various modifications of the system 10 will be described hereinafter.

FIG. 8 shows the DTV 20 of FIGS. 3 and 4. The DTV 20 comprises two finger members 40, namely the first finger member 42 and the second finger member 44 provided in the end portions of the LHD 34 in the longitudinal direction X. In FIGS. 3 and 4, the horizontal distance (in the direction X) between the finger members 42 and 44 is selected, by way of example, such that (exactly) one transport container 16 fits between them. In FIG. 8, instead of the single transport containers 16-1 of FIG. 3, for example, two smaller transport containers 16-1 and 16-2 are used, which together may be as long as the transport container 16-1 of FIG. 3. These (smaller) transport containers 16-1 and 16-2 may be exchanged for two (correspondingly dimensioned) transport containers 16-3 and 16-4 placed on the first deposition location 30-1. The exchange takes place according to the same sequence already illustrated in FIG. 3. Thus, instead of one container 16, two containers 16 are exchanged simultaneously, but handled without spacing (in the direction X) between them. FIG. 9 likewise illustrates an exchange of, for example, two containers 16 using an LHD 34 comprising, by way of example, four finger members 40 arranged distributed along the longitudinal direction X. The LHD 34 may be configured to transport three containers 16 at the same time. The transport can take place with a spacing between the containers 16, which may be ensured by the additional finger members 46 between the first and second finger members 42 and 44.

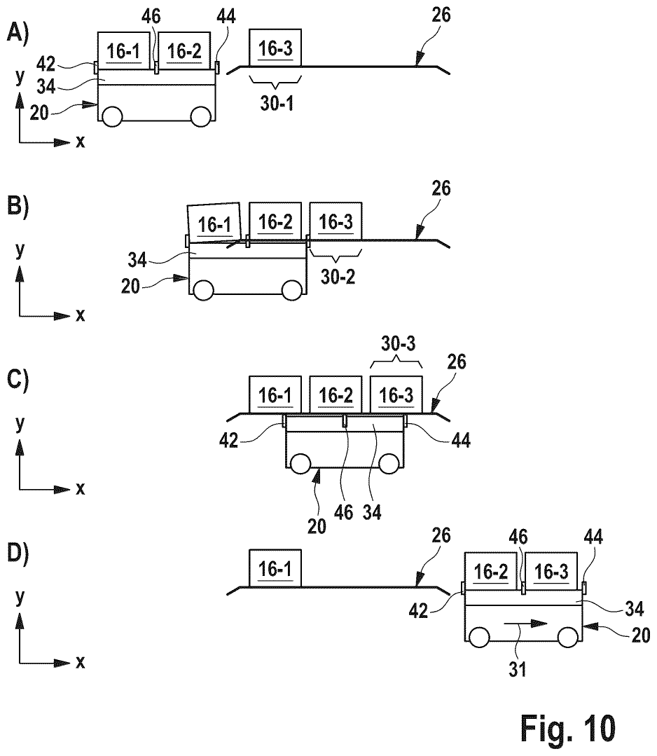

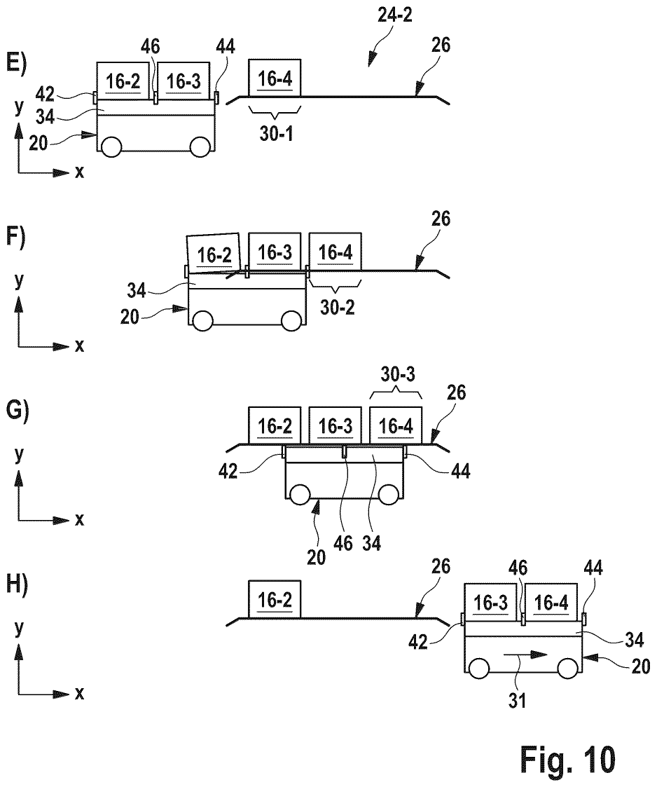

FIG. 10 illustrates an exchange of, for example, one container 16, although the LHD 34 may be configured to transport two or more containers 16 (spaced apart from one another). The container 16-1 is delivered, the container 16-2 remains on the DTV 20, and the container 16-3 is received by the DTV 20.

This enables the exchange of respectively one container 16 at two different stations 24. For example, starting from the situation of FIG. 10D, in order to exchange the container 16-2 at another station 24-2, the DTV 20 of FIG. 10D can travel into this station, FIG. 10E, and exchange a container 16-4 on the first deposition location 30-1 with the container 16-2, FIG. 10F-H.

For example, starting from the situation of FIG. 10D, in order to exchange the container 16-3 at the other station 24-2, the DTV 20 can also travel backward into the station 24-2 so that the first finger member 42 is positioned at the front and the second finger member 44 at the rear (not illustrated in FIG. 10).

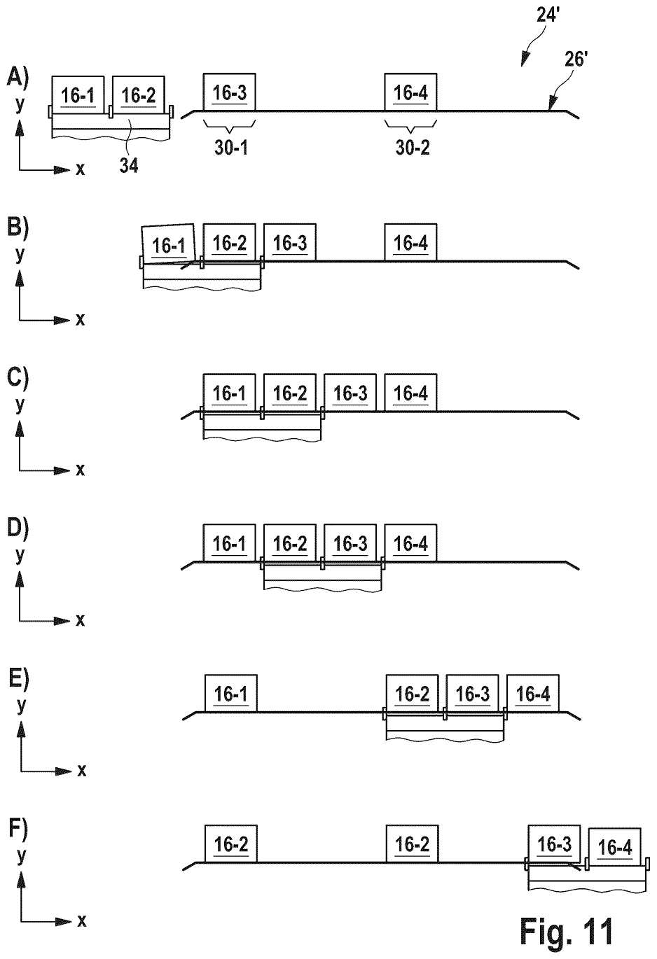

FIG. 11 illustrates an exchange of two containers 16 at the (same) station 24′, wherein the LHD 34 of FIG. 10 is used in particular. The station 24′ of FIG. 11 differs from the station 24 of FIG. 10 in that the first and second deposition locations 30-1 and 30-2 are spaced farther apart from one another in the longitudinal direction X. For the distance d between the first deposition location 30-1 and the second deposition location 30-2 d>2 L_{CONTAINER} applies, wherein L_{CONTAINER} indicates a (unit) length of the container 16 in the longitudinal direction X. The length of the station 24′ is correspondingly greater. In the example of FIG. 11, the transfer conveyor 26 of the station 24′ may be configured for the simultaneous receipt of, for example, six containers 16.

Thus, the FIGS. 8-11 illustrate a variety of possibilities for modifying the system 10.

### LIST OF REFERENCE NUMERALS

10 (intralogistics) system
12 transport item
14 workstation
16 container
18 carton
20 DTV (driverless transport vehicle)
22 DTS (driverless transport system)
24 transfer station
26 transfer conveyor
27 frame
28 deposition surface
30 deposition location
31 travelling direction of 20
32 housing of 20
34 LHD (load-handling device) of 20
36 webs/slats of 34
38 transport surface
40 finger members
42 first finger member, rear
44 second finger member, front
46 additional finger member(s)
48 control
50 rollers
52 floor
54 sliding-surface element

1. An intralogistics system for static provision of transport items comprising:
a driverless transport vehicle, DTV;
a transfer station for static provision of at least one of the transport items on a deposition surface of the transfer station and
a control;
wherein the DTV comprises a load-handling device, LHD, defining a transport surface on an upper side of the DTV on which the at least one of the transport items rests during transport travel, wherein the LHD comprises, along a travelling direction of the DTV, a first finger member and a second finger member each of which is switchable between a raised position and a lower position;
wherein the transfer station is configured to buffer, one behind the other, at least two of the transport items on a corresponding plurality of deposition locations on the deposition surface;
wherein the transfer station comprises a multi-track transfer conveyor defining the deposition surface;
wherein the transfer conveyor and the LHD are configured to exchange with each other each of the to-be-provided transport items meshingly by the DTV travelling through the transfer station; and
wherein the control is configured to switch each of the finger members depending on a travelling depth between the positions while the DTV travels through the transfer station.

2. The intralogistics system of claim 1, wherein each of the finger members in the respective raised position, projects beyond the deposition surface and the transport surface, and in the respective lowered position is positioned below the deposition surface.

3. The intralogistics system of claim 1, wherein the deposition locations are spaced apart from one another in the travelling direction of the DTV.

4. The intralogistics system of claim 1, wherein the DTV travels through the entire transfer station without change of travelling direction.

5. The intralogistics system of claim 1, wherein each of the transport items is standardized with respect to its width.

6. The intralogistics system of claim 1, wherein at least the first finger member is in the raised position upon travelling into the transfer station, is switched into the lowered position during the passage depending on the first travelling depth, and is then switched back into the raised position depending on a second travelling depth, wherein the first travelling depth is smaller than the second travelling depth.

7. The intralogistics system of claim 1, wherein
the deposition surface is defined by uppermost points of the multi-track transfer conveyor, and
the deposition surface is arranged higher than the transport surface.

8. The intralogistics system of claim 1, comprising a sensor for determining a current position of the DTV, wherein
the control is electronic;
the control communicates with the sensor;
the control is configured to determine the travelling depth of the DTV and
the control is configured to generate signals, based on the travelling depth DT, causing the finger members to be moved into their raised position and into their lowered position.

9. A method for static provision of transport items in an intralogistics system which comprises: a driverless transport vehicle, DTV, including a load-handling device, LHD, which comprises first and second finger members respectively switchable between a raised position and a lowered position; a transfer station including a transfer conveyor for static provision of at least one of the transport items on a deposition surface of the transfer station, which includes first and second deposition locations wherein the transfer conveyor and the LHD are configured to meshingly exchange with each other the to-be-provided transport items by the DTV travelling through the transfer station; and a control; wherein the method comprises the following steps:
the DTV travelling into the transfer station the DTV loaded with a first one of the transport items, wherein the first and second finger members are in their raised positions;
while the DTV travels in pushing the first transport item with the first finger member onto the first deposition location and pulling a second one of the transport items located already on the first deposition location which is defined by the transfer conveyor, with the second finger member onto the second deposition location;
once the first transport item is pushed on the first deposition location, moving the first and second finger members in their lowered positions, the DTV continuing to travel with lowered first and second finger members until the first finger member is movable into its raised position without repositioning the first transport item on the first deposition location and then moving the first finger member into its raised position; and
pulling the second transport item from the second deposition location with the first finger member while the DTV, the first finger member of which is again in the raised position, travels out of the transfer station.

10. The intralogistics system of claim 1, wherein the transfer conveyor, which defines the deposition surface, is non-driven.

11. The intralogistics system of claim 4, wherein the DTV travels through the entire transfer station without change of travelling direction in order to deliver a first one of the transport items to the transfer station and to receive a second one of the transport items from the transfer station during the same passage.

12. The intralogistics system of claim 5, wherein each of the transport items is also standardized with respect to its length.

13. The intralogistics system of claim 8, wherein the sensor determines the current position of the DTV while the DTV travels through the transfer station.
